(19) United States
(12) Patent Application Publication
(10) Pub. No.: US 2003/0047216 A1
(43) Pub. Date: Mar. 13, 2003

(54) Pop-type pressure relief valve

(76) Inventor: Paul A. Kelly, Springfield, IL (US)

Correspondence Address: SONNENSCHEIN NATH & ROSENTHAL, P.O. Box 061080, Wacker Drive Station, Sears Tower, Chicago, IL, 60606-1080, US

(21) Appl. No.: 09/949,348

(22) Filed: Sep. 7, 2001

(51) Int. Cl. F16K 15/00

(52) U.S. Cl. 137/538

(57) ABSTRACT

A pressure relief valve and method of preparation is provided in which the relief valve includes a body having a seat disposed in a passageway. The relief valve also includes a piston sealing a gasket against the seat by a spring. The spring is adjusted and retained by an adjusting gland. The piston includes a cone that aids in reclosing the valve quicker than it would close without the cone. The relief valve has a low blowdown and may be easily assembled and then shipped on the same day.

### BACKGROUND OF THE INVENTION

The present invention generally relates to relief valves and more specifically to a low blowdown relief valve used in the refrigeration and air conditioning industry that may be easily assembled and then shipped on the same day.

Both refrigeration and air conditioning systems employ liquid/vapor mix refrigerant fluids that are under pressure. Under some circumstances, such as when operating controls fail or when the system is exposed to excessive heat, the pressure may build up to a value that is greater than normal operating pressure. If pressure were to build up high enough to cause the system to rupture, large quantities of liquid refrigerant would be released. The rupture would result in a sudden reduction of pressure so that the liquid released is vaporized almost instantly, with explosive results.

To release the refrigerant at a controlled rate and to maintain a safe pressure within refrigeration and air conditioning systems, each system includes several pressure relief valves. A pressure relief valve is a pressure-actuated valve held closed by a spring and designed to automatically relieve at a predetermined pressure. The most popular type of relief valve is the direct-spring-loaded pop-type. In this type, a piston housed in a body conventionally contains a Teflon seat disc that is urged to seal against a valve seat at a set pressure by a spring whose compression is controlled by an adjusting gland.

At the relief valve setting, the set pressure force exerted by the spring is equal to the force exerted by, for example, a refrigerant pressure. As the system pressure increases above the setting, the valve will begin to seep until there is enough flow to pop the piston open and provide full discharge. The pressure above the setting at which the piston is fully open depends upon the valve design. Since the flow rate conventionally is measured at a pressure of 10% above the setting, it is necessary that the valve reliably open within this 10%. This requirement is set out in American Society of Mechanical Engineering (ASME) Standard, Section VIII Div I, sec UG 131, para c1.

Pressure relief valves are designed to reclose automatically. This is done at a predetermined reclosing pressure after the valve has discharged so as to only expel a measured volume of fluid. The ratio of the difference between the set pressure and the reclosing pressure to the set pressure is called the blowdown. As the percentage by which the reclosing pressure is maintained below the set pressure increases, the amount of gas or vapor that is discharged from a refrigeration or air conditioning system increases. The blowdown will vary with the valve design and is between 40% to 60% for most conventional pop-type relief valves.

In addition to a high discharge capacity, the advantages of a conventional pop-type relief valve are generally understood to be simplicity of design and low initial cost. However, the basic design of these valves has not been improved upon in the past 40 years. This has lead to problems in manufacturing, assembly, and operation so as to remove simplicity of design and low initial cost advantages.

By themselves, the number of parts of conventional relief valves makes it difficult to assemble the valve. Many of these parts require dedicated features to be machined into the interior cavity of the relief valve body. Machining the relief valve body is difficult and expensive.

The seat disc of conventional pressure relief valves causes other problems. Generally, the synthetic rubber seat disc typically is made of Teflon. Properly installing a Teflon seat disc requires a long processing time, which, in turn, results in an increase in the initial cost of the valve. Although most manufacturers use polymers such as virgin Teflon or other filled grades as a function of the application, some manufacturers use 100% neoprene seat discs. Although neoprene is easier to set, neoprene tends to degrade over time when exposed to refrigerant.

A Teflon seat disc requires operators to engage in a time-consuming two-step process. First, the operator must assemble the valve and preload the seat disc with the spring to a set pressure so as to allow the Teflon to take an initial set. After 24 hours, the operator must then check the set pressure of the valve to determine whether the set pressure is at the desired set pressure. If the operator is required to readjust the set pressure, the operator will turn the adjusting gland so as to further compress the spring. Either way, the operator will again verify that the set pressure of the valve is within the design set pressure tolerance after 24 more hours.

After this 48 hour process, the relief valve may be ready for shipment to a customer. However, not only are conventional pressure relief valve designs difficult to set, it is very difficult to ensure repeat set and pop performance that is in compliance with Standard 15 of the American Society of Heating, Refrigerating and Air Conditioning Engineers (ASHRAE). The unreliable set pressure and pop pressure creates time-consuming problems at the American National Standards Institute National Board (ANSI NB) testing lab and results in high scrap rates. Even if the relief valve is ready for shipment to a customer after 48 hours, this long production lead-time creates a variety scheduling problems.

As noted above, the blowdown is between 40% to 60% for most conventional pop-type relief valves. However, recent pending European regulations seek to minimize refrigerant discharge and now require employed relief valves to have a blowdown of not greater than 10%. Thus, there is a need for a low blowdown ratio relief valve used in the refrigeration and air conditioning industry that may be easily assembled and then shipped on the same day.

### SUMMARY OF THE INVENTION

A pressure relief valve and method of preparation is provided in which the relief valve includes a body having a seat disposed in a passageway. The relief valve also includes a piston sealing a gasket against the seat by a spring. The spring is adjusted and retained by an adjusting gland. The piston includes a cone that aids in reclosing the valve quicker than it would close without the cone. The relief valve has a low blowdown and may be easily assembled and then shipped on the same day.

### BRIEF DESCRIPTION OF THE DRAWINGS

FIG. 1 is an elevation sectional view of a valve 100.

FIG. 2 is a plan view of the piston 200.

FIG. 3 is a sectional view of the piston 200 taken generally off of line 3-3 of FIG. 2.

FIG. 4 is a bottom view of the piston 200.

FIG. 5 is an enlarged view of the groove 204 taken generally off of line 5 of FIG. 3.

FIG. 6 is a plan view of the gasket 300.

FIG. 7 is an elevation view of the spring 400.

FIG. 8 is a bottom view of the adjusting gland 500.

FIG. 9 is a sectional view of the adjusting gland 500 taken generally off of line 9-9 of FIG. 8.

FIG. 10 is a block diagram of the production process 600 of the invention.

FIG. 11 is a block diagram of the operation process 700 of the invention.

### DETAILED DESCRIPTION OF THE PREFERRED EMBODIMENTS

The present invention relates to relief valves and can be employed in a wide variety of constructions and arrangements. While several of such arrangements are illustrated herein, there are numerous other embodiments and constructions in which the present invention can be realized. Other arrangements will be apparent to a person of skill in the art from the following description of the preferred embodiments.

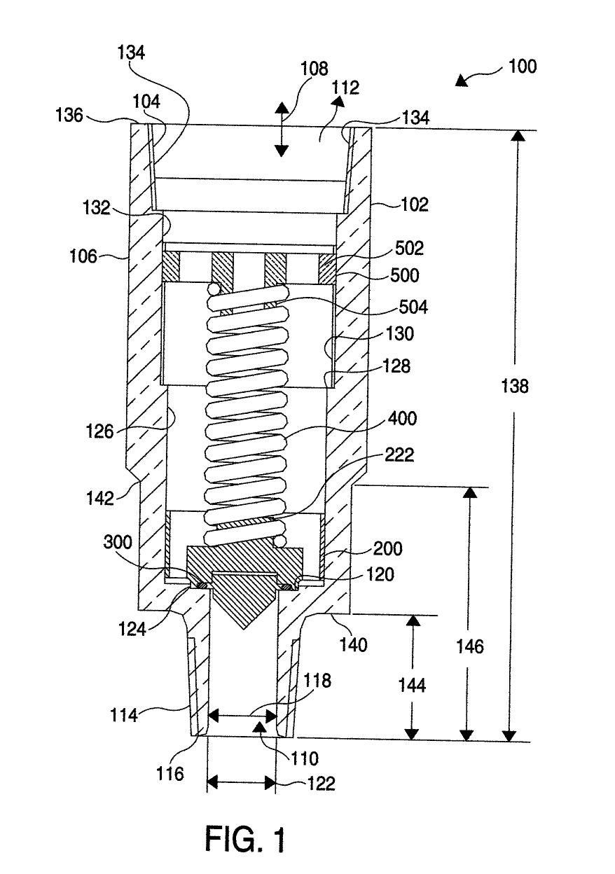

FIG. 1 is an elevation sectional view of a valve 100. The valve 100 may be referred to as a relief valve or as a pop-type relief valve. The valve 100 may also be referred to as a safety valve or an escape valve. In general, the valve 100 may be any pressure-actuated valve that is held closed by an elastic force and adapted to automatically relieve at a predetermined set pressure.

The valve 100 may be adapted to be mounted to a vessel that is designed to operate under pressure. Although the vessel may be part of a refrigeration system or an air conditioning system, the valve 100 may be used in any system where there is a need to release a fluid under pressure, such as steam, air, liquid, and gas/vapor, and to maintain a safe pressure within the system. To aid in adapting the valve 100 to be mounted to a vessel, the valve 100 may include a body 102.

The body 102 may be a rigid structure against which other parts may be registered. In one embodiment, the body 102 may be made from at least one of brass, cast iron, carbon steel, and stainless steel. The material of the body 102 may be a function of the set pressure at which the valve 100 relieves. The set pressure for the valve 100 may range about from 10 through 45 kilograms per square centimeter (KPSC) (150 through 625 pounds per square inch (PSI)). Depending on the material composition, the valve 100 may be made from a non-metallic material, such as plastic.

The body 102 may define an interior 104 and an exterior 106. The interior 104 may define a passageway 108 that is comprised of an inlet 110 and an outlet 112. Sonic flow may be thought of as the maximum flow of a fluid through a valve for a given inlet where a minimum orifice cross section of the inlet largely dictates the flowrate; that is, for a fluid moving at sonic flow the flow will not increase even if the outlet or “set” pressure is reduced. The passageway 108 may include an annular cavity that substantially permits a sonic flow from the inlet 110 through the outlet 112. Flow at the outlet 112 may be subsonic due to an increase in the cross sectional area of the passageway 108 at that location.

To aid in mounting the body 102 to a vessel, the body 102 may include threads 114. The threads 114 may be dry-seal threads that allow for joining without sealants. In one embodiment, the threads 114 may be ½″-14 National Standard Free-Fitting Tapered Mechanical Pipe Threads (NPTF). The threads 114 may be male threads that extend along the exterior 106 to a surface 116. The surface 116 may meet the inlet 110 at a furthest most end of the body 102.

The body 102 may further include an orifice 118 and a seat 120. The orifice 118 may extend from the surface 116 to the seat 120 as part of the passageway 108 as defined by a diameter 122. The seat 120 may be a flat surface having a fine tool finish against which a gasket may seal. In one embodiment, the seat 120 may be about 1.3 centimeters (cm) (½ inch (″)).

Radially outward from the seat 120 may be an elbow 124. The elbow 124 may be an annular ring disposed as a feature of the interior 104 that widens the dimensions of the passageway 108. Immediately radially outward of the elbow 124 may be a surface 126. The surface 126 may extend as part of the passageway 108 to a seat 128. The seat 128 may be disposed between a surface 126 and threads 130. The threads 130 may be female Unified inch screw threads such as 1-5/16″-28 UN having a class 2B internal thread pitch diameter tolerance.

The threads 130 may extend as part of the passageway 108 to a surface 132. Similar to the surface 126, the surface 132 may extend as part of the passageway 108. A height of the surface 132 may be equal to or greater than a thickness of a base 502 of an adjusting gland 500 (FIG. 1 and FIG. 9). In assembling the valve 100, the surface 132 may act as a guide for the adjusting gland 500 while a spring 400 (FIG. 1 and FIG. 7) is uncompressed. In one embodiment, the height of the surface 132 of FIG. 1 is about 0.16 cm (1/16 inches) greater than the thickness of the base 502.

Immediately radially outward of the surface 132 may be threads 134. The threads 134 may be female threads that form the remainder of the passageway 108 and may be used to couple the valve 100 to other structures. In one embodiment, the threads 134 may be 1¼″-11.5 NPTF.

The body 102 may include a surface 136 as the most remote feature from the surface 116. The exterior 106 may be disposed between the surface 116 and the surface 136 to define a height 138. Moreover, the exterior surface 106 may include a stop 140 and a jog 142. The stop 140 may be disposed approximately at a distance of a stop height 144 from the surface 116 such that a ratio of the height 138 to the stop height 144 may be approximately 4.8:1.0. The jog 142 may be disposed approximately at a distance of a jog height 146 from the surface 116 such that a ratio of the jog height 146 to the stop height 144 may be approximately 2.0:1.0.

To adapt the valve 100 to be held closed by an elastic force and to automatically relieve at a predetermined set pressure, the valve 100 may further include a piston 200, a gasket 300, and the spring 400 and the adjusting gland 500 mentioned above.

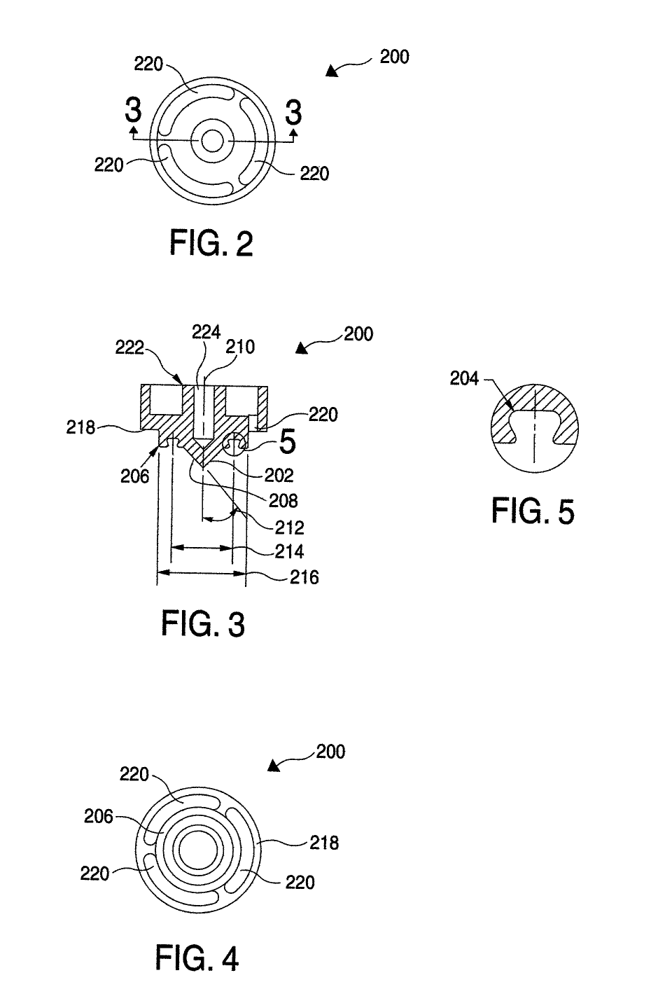

FIG. 2 is a plan view of the piston 200. FIG. 3 is a sectional view of the piston 200 taken generally off of line 3-3 of FIG. 2. FIG. 4 is a bottom view of the piston 200. Conceptually, the piston 200 may be any piece that slides within the interior 104 of the body 102 and that is adapted to move under fluid pressure.

The piston 200 may include a cone 202, a groove 204, and a ring 206. The cone 202 may be thought of as a nose cone. Moreover, the cone 202 may be a forwardmost section of the piston 200 that includes a cone surface 208. The piston 200 may define an axis 210 such that the cone 202 may be defined with respect to the axis 210.

In operation, the cone surface 208 first may experience static fluid forces and then dynamic fluid forces in addition to the static fluid forces. Reducing the dynamic forces of an applied fluid on the piston 200 works to reduce the difference between the static fluid force required to open the piston 200 and the dynamic fluid force required to close the piston 200. The cone surface 208 may be shaped to offer minimum fluid dynamic resistance so as to reduce the dynamic forces of an applied fluid on the piston 200. Put another way, forces on the piston 200 are essentially static up until a point where the valve 100 pops open. Where dynamic forces are generated by fluid impinging on the cone 202, the dynamic forces are reduced significantly by the cone 202 as compared to a flat piston surface that conventionally faces such dynamic forces. This reduction, in turn, creates a reduction between the fluid force needed to open the piston 200 and the fluid force at which the piston 200 recloses. In other words, the elastic force provided by the spring 400 now quickly overcomes the fluid force to reclose the piston 200 due to the addition of the cone 202 to the piston 200. Thus, rather than a blowdown of 40% to 60% as in the conventional pop-type relief valve, the valve 100 is characterized by a blowdown of not greater than 10%.

A Mach number represents a ratio of the speed of an object, body, or projectile (Vp) to the speed of sound (c) in a surrounding, relatively stationary medium. For example, an aircraft moving twice as fast as the speed of sound is said to be traveling at Mach 2. An aircraft moving as fast as the speed of sound is said to be traveling at Mach 1.

Drag represents resistance of motion of a projectile through a fluid. For example, a bullet traveling through air experiences resistance to its forward motion due to the air. Drag may be represented in a drag coefficient (CD), where the drag coefficient is the ratio of the drag (D) on a projectile moving through a fluid to the product of the velocity (Vp) and the surface area (Ap) of the projectile. For a flat surface of a cylinder projectile passing through a relatively stationary fluid at Mach 1, the drag coefficient is 1.0. If a round -nose projectile were to pass through this same fluid, the drag coefficient drops to around 0.30. Where a sharp-nose projectile is used, the drag coefficient drops to around 0.25. In other words, as the face of the projectile becomes more streamlined, the resistance to the motion of the projectile passing through the fluid decreases.

One reason for the drop in drag coefficient may be due the separation of the X and Y reaction force (F) components on the projectile. For a flat faced projectile, the horizontal force component (F_{X}) represents 100% of the reaction force and the vertical force component (F_{Y}) represents zero of the reaction force. Where the face of the projectile is shaped to be symmetrically streamline, the horizontal force component (F_{X}) reduces from representing 100% of the reaction force and the vertical force component (F_{Y}) increases. Since the streamline of the projectile is symmetrical, the projectile experiences evenly distributed vertical force components (F_{Y}) that cancel each other out. The overall effect works to decrease the resistance to the motion of projectile passing through the stationary fluid.

Rather than dealing with an aircraft or bullet moving through air at Mach 1, the inventor of this invention was faced with the problems associated with high pressure, confined refrigerant vapor passing over a flat faced piston of a pop-type pressure relief valve at approximately sonic velocity. In particular, the inventor was faced with reducing the blowdown ratio for such a relief valve used in the refrigeration and air conditioning industry while ensuring that the relief valve was easy to assemble and ship on the same day.

A round-nose shape or a sharp-nose shape may define the cone surface 208. In one embodiment, passing a line through a fixed vertex point and moving the line along a fixed directrix curve may generate the cone surface 208. Although a straight line generated the cone surface 208 shown in FIG. 3, the passed line may be a curved or other shaped line. Alternatively, the cone surface 208 may be defined by an angle 212 as measured between the cone surface 208 and the axis 210. In one embodiment, the angle 212 may be a value approximately from about 30 degrees through about 60 degrees. In another embodiment, the angle 212 may be 45 degrees, plus or minus 5 degrees with a fixed directrix curve having a diameter of 0.60 cm, plus or minus 0.15 cm (0.23 inches, plus or minus 0.05 inches).

The groove 204 may be defined by a narrow channel having dovetail features that are adapted to retain the gasket 300 and prevent the gasket 300 from blowing out of the valve 100 along with any expelled fluid. FIG. 5 is an enlarged view of the groove 204 taken generally off of line 5 of FIG. 3. In one embodiment, the groove 204 may have a socket cross section shaped to tightly fit a bird's tail-spread so as to resist pulling the gasket 300 in all directions except one. The groove 204 may define a groove diameter 214.

As noted above, the piston 200 may include a ring 206. The ring 206 may have an interior shape that defines part of the groove 204 and an exterior annulus shape that defines a ring diameter 216. By way of explanation, increasing the diameter 216 with respect to the diameter 214 may cause the valve 100 to pop sooner. However, this will also increase the blowdown. Thus, to ensure that the piston 200 reliably pops at a predetermined pop pressure, it is desirable to minimize the ring diameter 216 with respect to the groove diameter 214. In one embodiment, the ratio of the ring diameter 216 to the groove diameter 214 may be a value from 1.4 to 1.5. In another embodiment, the ratio of the ring diameter 216 to the groove diameter 214 is about 1.44.

The diameter 216 may influence the blowdown. Blowdown is the difference between the pressure at which an applied static fluid force overcomes a force of the spring 400 (the set pressure) and the pressure at which the compression force of the spring 400 overcomes an applied dynamic fluid force (the reclosing pressure). As the percentage by which the reclosing pressure is maintained below the set pressure increases, the amount of gas or vapor that is discharged from a refrigeration or air conditioning system increases. Conventional blowdowns are between 40% to 60% for most pop-type relief valves.

A blowdown target of 10% applies to 10% of valve rated pressure. Accordingly, for a set pressure of 400 pounds per square inch (PSI) and a blowdown of 10%, the valve reseats at 360 PSI (=400−(400)(10%)). To ensure a blowdown of no greater than 10%, it is important that the diameter 216 be made a function of the cone 202. There are other factors that may need to be addressed. For example, the diameter 216 may need to be kept to a minimum to present a minimum projected area of jet on disc. Here, the diameter 216 is a function of the mechanical strength required to retain the O-ring 300 as the O-ring 300 expands radially outwards under pressure. A ratio of the diameter 216 to a seal diameter may range from 1.5 to 2.0 as determined through experimentation by the inventor of this invention. Moreover, although a higher value for the diameter 216 to a seal diameter ratio may help the pop action, such an increase in ratio will increase blowdown. Here, the cone 202 works towards streamlining the flow of the working fluid much like the atmospheric force a jet experiences on an inclined plane.

Immediately radially outward from the ring 206 may be the shoulder 218. The shoulder 218 may increase that surface area of the piston 200 that experiences the dynamic forces of an applied fluid. As best seen in 4, the ring 206 and the shoulder 218 may define ports 220. The ports 220 may work as exhaust ports to permit fluid to pass through an area of the piston 200. To ensure that the piston 200 does not restrict the flow of fluid, the total cross sectional area of the ports 220 may be twice the total cross sectional area of the orifice 118 (FIG. 1) of the body 102.

The piston 200 may further include a guide 222 and a core 224. The guide 222 may be an elevated peg structure about which the spring 400 may fit. The core 224 may aid in handling the piston 200 during manufacture of the piston 200. Moreover, the core 224 may be used to maintain a uniform section thickness for injection molding where the piston 200 is made of an injection molded plastic.

The piston 200 may be made of a thermoplastic polyamide having high strength, toughness, and resistance to abrasion, most chemicals, and repeated impact. In one embodiment, the piston 200 may be made of Zytel® nylon resin from Dupont, Inc. of Wihnington, Del. Alternatively, the piston 200 may be made of metal, such as brass. Where the piston 200 is made of metal, the piston 200 may be made of two individual pieces: the cone 202 and the remainder of the piston 200. The piston 200 made of two individual pieces is shown in FIG. 1. A two-piece piston 200 may be required where it is difficult to machine the groove 204 as a dovetail groove.

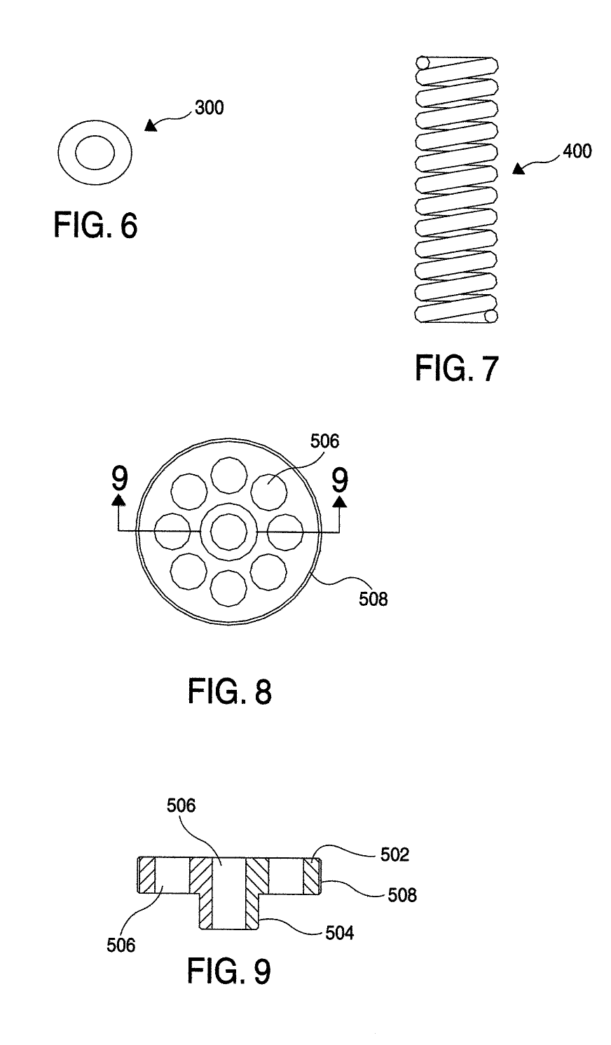

FIG. 6 is a plan view of the gasket 300. To provide a snug fit within the groove 204 of the piston 200, the gasket 300 may be in the shape of an O-ring. The O-ring may be a Teflon coated neoprene O-ring, such as a size 015 O-ring made of compound #3110-70 as manufactured by Parco, Inc. of Ontario, Calif. Teflon is a registered trademark for polytetrafluoroethylene, a white, waxy solid polymer. Use of a Teflon coated neoprene O-ring works to minimize setting problems associated with using an O-ring made completely of Teflon. This combination beneficially provides the resilience of neoprene with the chemical compatibility of Teflon.

FIG. 7 is an elevation view of the spring 400. The spring 400 may be an elastic body of any kind that is adapted to regulate the motion of the piston 200. Examples of materials that may be used as part of an elastic body include steel, rubber, or compressed air. Although an example of the spring 400 may be a coil of wire, the spring 400 is not limited to this construction. In general, the spring 400 may be any elastic device that works to regain its original shape after being compressed. Where the spring 400 is a coil spring, the coil spring may include flat ground end surfaces so as to more evenly spread the forces between the spring 400 and surfaces against which it is mounted. The spring 400 may be made of music wire coiled for a KPSC setting about from 10 through 45 KPSC (150 through 625 PSI), such as the range set of 10 to 19, 20 to 26, 27 to 35, and 36 to 45 KPSC (150 to 274, 275 to 374, 375 to 499, and 500 to 625 PSI).

FIG. 8 is a bottom view of the adjusting gland 500. FIG. 9 is a sectional view of the adjusting gland 500 taken generally off of line 9-9 of FIG. 8. The adjusting gland 500 may include a base 502 and a guide 504. Together, the base 502 and the guide 504 may work to adjust the set pressure of the spring 400 as well as permit the exhaust of liquid from the vessel against which the valve 100 may be mounted.

The base 502 may be in the shape of an annular disk within which ports 506 may be disposed. Similar to the ports 220, the ports 506 may work as exhaust ports to permit fluid to pass through an area of the adjusting gland 500. To ensure that the adjusting gland 500 does not restrict the flow of fluid, the total cross sectional area of the ports 506 may be twice the total cross sectional area of the orifice 118 (FIG. 1) of the body 102.

Disposed about an exterior perimeter of the base 502 may be threads 508. The threads 508 may male threads that mate with the threads 130 (FIG. 1) of the body 102. In one embodiment, the threads 508 may be male Unified inch screw threads such as 1-5/16″-28 UN having a class 2A external thread pitch diameter tolerance. As seen in FIG. 1, the guide 504 may cooperate with the guide 222 of the piston 200 to maintain a relatively straight alignment of the spring 400.

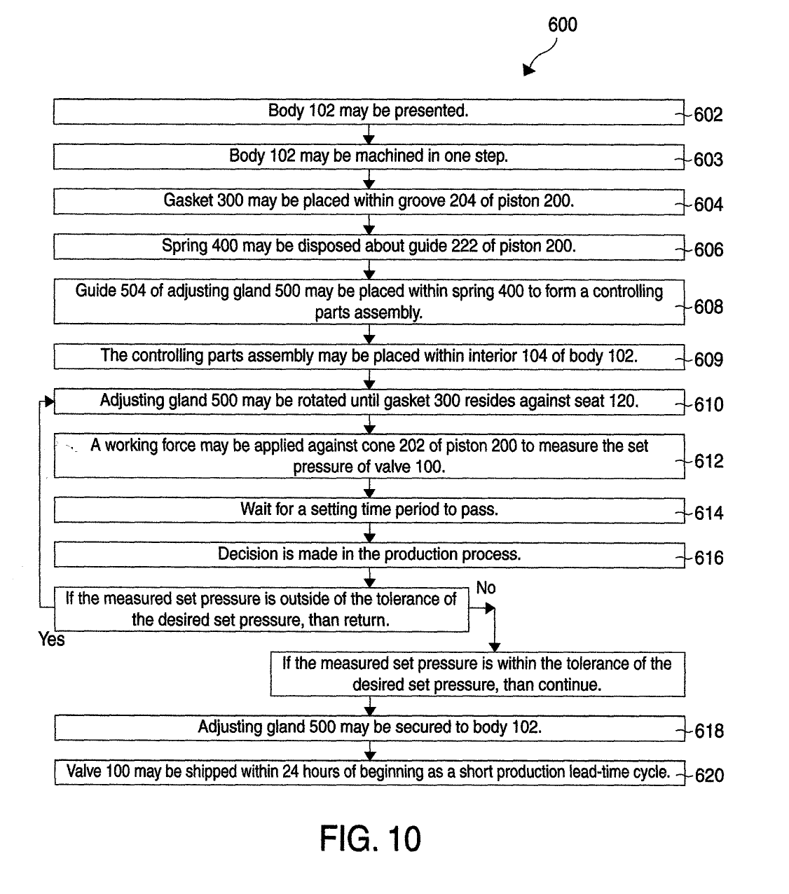

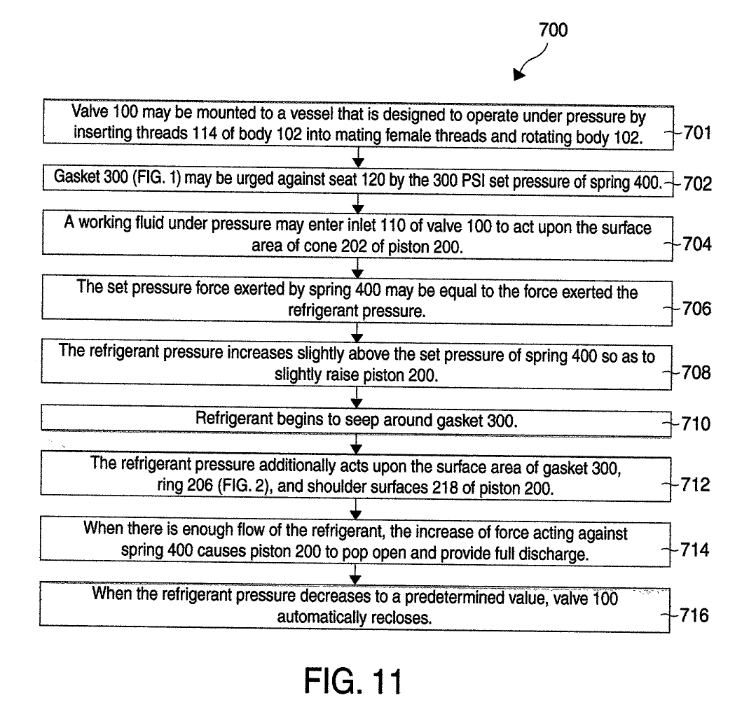

FIG. 10 is a block diagram of the production process 600 of the invention. At 602, the body 102 may be presented. At 603, the body 102 may be machined in one step. Fixing the body 102 within a lathe having opposing drills may perform machining the body 102 in one step. Other working tools designed to cut metal, such as a laser or high pressure water, may be used. A first drill profiled to hog out the passageway 108 from the surface 136 (FIG. 1) to the seat 120 may be inserted into the outlet 112 at the surface 136. Simultaneously with the first drill, a second drill profiled to hog out the passageway 108 from the surface 116 and to form the threads 114 may be disposed about the surface 116. The first drill may include a cavity to receive into it the second drill so as to ensure cylindrical machining about an elongated central axis of the body 102 that is within specified tolerances. Alternatively, the first drill may include a cutting blade to remove material from the inlet 110 to the surface 116.

In a most efficient form, the body 102 includes no more than five features: the seat 120, the elbow 124, the threads 130, the inlet 110, and the threads 114. Where machining produces the body 102, these five features may be referred to as machined features. Thus, the first drill and the second drill need only include blades to remove material from the body 102 to form the seat 120, the elbow 124, the threads 130, the inlet 110, and the threads 114. Since the body 102 need only be machined to form five features, the body 102 is an inexpensive body to machine. Moreover, since only two working tools are needed to form the five features, the body 102 is a relatively easy body to machine. The body 102 also may be made from a single injection molding process.

At 604, the gasket 300 may be placed within the groove 204 of the piston 200. At 606, the spring 400 may be disposed about the guide 222 of the piston 200. And at 608, the guide 504 of the adjusting gland 500 may be placed within the spring 400 to form a controlling parts assembly.

At 609, the controlling parts assembly may be placed within the interior 104 of the body 102. At 610, the adjusting gland 500 may be rotated until the gasket 300 resides against the seat 120. At 612, a working force may be applied against the cone 202 of the piston 200 to measure the set pressure of the valve 100. In one embodiment, the desired set pressure maybe from 10 through 45 KPSC (150 through 625 PSI).

At 614, an operator may wait for a setting time period to pass. In one embodiment, the setting time period is less than 24 hours. In another embodiment, the total setting time for each setting time period is less than 24 hours.

At 616, a decision is made in the production process 600. If the measured set pressure is outside of the tolerance of the desired set pressure, than the production process 600 may return to step 610. If the measured set pressure is within the tolerance of the desired set pressure, then production process 600 may continue to step 618. Since a Teflon coated neoprene O-ring gasket replaces the Teflon sealing gasket in one embodiment, setting and resetting is made easier.

At 618, the adjusting gland 500 may be secured to the body 102. The adjusting gland 500 may be secured to the body 102 by, for example, using a Loctite® 290 threadlocker product from Loctite Corporation of Rocky Hill, Conn. or by welding the adjusting gland 500 to the body 102 by tungsten inert gas (TIG) welding. At 620, the valve 100 may be shipped within 24 hours of beginning step 602. This is a short production lead-time cycle.

FIG. 11 is a block diagram of the operation process 700 of the invention. For the operation process 700, the set pressure is assumed to be about 21 KPSC (300 PSI). However, the set pressure may be any value according to the application of the valve 100. Preferably, the valve 100 may react to refrigerant vapor or any other compressible fluid since, under some circumstances, if used with liquid only, the liquid may merely seep around the set pressure and the valve 100 may not fully pop open.

At 701, the valve 100 may be mounted to a vessel that is designed to operate under pressure by inserting the threads 114 of the body 102 into mating female threads and rotating the body 102. At 702, the gasket 300 (FIG. 1 and FIG. 6) may be urged against the seat 120 by the 21 KPSC (300 PSI) set pressure of the spring 400. At 704, a working fluid under pressure may enter the inlet 110 of the valve 100 to act upon the surface area of the cone 202 of the piston 200.

The working fluid may be refrigerant from an air conditioning system or refrigerant from a refrigeration system. Refrigerant may be a substance, such as air, ammonia, water, or carbon dioxide, used to provide cooling either as the working substance of a refrigerator or air conditioner or by direct absorption of heat. As other examples, the working fluid may be water, brine, or gas. In general, the working fluid is a function of the system into which the valve 100 is located. By way of example and not limitation, the working fluid will be referred to as refrigerant in FIG. 11.

At 706, the set pressure force exerted by the spring 400 may be equal to the force exerted the refrigerant pressure. Here, the pressure of the refrigerant only acts upon the surface area of the cone 202. At 708, the refrigerant pressure may increase slightly above the set pressure of the spring 400 so as to slightly raise the piston 200. At 710, refrigerant begins to seep around the gasket 300. At 712, the refrigerant pressure additionally acts upon the surface area of the gasket 300, the ring 206 (FIG. 2), and the shoulder surfaces 218 of the piston 200. Since the same pressure begins to act on an increased surface area, the amount of force applied against the spring 400 by the refrigerant increases (recall that force (F) equals pressure (P) times unit area (A) or F=PxA).

When there is enough flow of the refrigerant, the increase in force acting against the spring 400 causes the piston 200 to pop open and provide full discharge at 714. Due to the invention, the valve 100 reliably pops opens before the refrigerant pressure reaches 23 KPSC (330 PSI); that is, the valve 100 reliably pops opens before the refrigeration pressure is beyond 110% of the 21 KPSC (300 PSI) set pressure of spring 400.

The valve 100 efficiently discharges refrigerant due to a better sonic flow through the valve 100. As the valve 100 discharges refrigerant, the refrigerant pressure decreases. When the refrigerant pressure decreases to a predetermined value, the valve 100 automatically recloses at 716. Since the valve 100 is designed to open and close at predetermined fluid pressures, only a known, controlled volume of refrigerant is expelled from the system as a function of the system settings.

Recall that the difference between the set pressure and the reclosing pressure is called the blowdown. The blowdown is about 40% to 60% for most conventional pop-type relief valves. For a conventional valve having a set pressure of 21 KPSC (300 PSI), the valve may close in this example when the refrigerant pressure drops to 11 KPSC (150 PSI). Here, due to the invention, the valve 100 reliably recloses before the refrigerant pressure reaches 19 KPSC (270 PSI); that is, the valve 100 reliably recloses before the refrigeration pressure is less than 90% of the 21 KPSC (300 PSI) set pressure of the spring 400. Accordingly, the invention works to ensure that the blowdown of the valve 100 reliably is not greater than 10%.

As is apparent from the foregoing specification, the invention is susceptible of being embodied with various alterations and modifications that may differ particularly from those that have been described in the preceding specification and description. It should be understood that we wish to embody within the scope of the patent warranted hereon all such modifications as reasonably and properly come within the scope of our contribution to the art.

What is claimed is:

1. A pressure relief valve comprising:
a body having a seat disposed in a passageway;
a gasket disposed on the seat;
a piston disposed on the gasket, wherein the piston includes a cone;
an adjusting gland; and
a spring disposed between the piston and the adjusting gland.

2. The pressure relief valve of claim 1, wherein the body includes no more than five machined features.

3. The pressure relief valve of claim 2, wherein the machined features are arranged with respect to one another such that the machined features are adapted to be produced in one step.

4. The pressure relief valve of claim 1, wherein the gasket is a polytetrafluoroethylene coated neoprene O-ring.

5. The pressure relief valve of claim 1, wherein the cone of the piston defines a cone surface and wherein the cone surface is defined by passing a line through a fixed vertex point and moving the line along a fixed directrix curve.

6. The pressure relief valve of claim 1, wherein the cone of the piston defines a cone surface and wherein the cone surface is defined by an angle disposed between the cone surface and an axis, wherein the angle defines a value from about 30 degrees through about 60 degrees.

7. A pressure relief valve for a system using refrigerant under pressure, the pressure relief valve comprising:
a body having a seat disposed in a passageway;
a gasket disposed on the seat;
a piston disposed on the gasket, wherein the piston includes a cone;
an adjusting gland; and
a spring disposed between the piston and the adjusting gland.

8. The pressure relief valve of claim 7, wherein the body includes no more than five machined features.

9. The pressure relief valve of claim 8, wherein the machined features are arranged with respect to one another such that the machined features are adapted to be produced in one step.

10. The pressure relief valve of claim 7, wherein the gasket is a polytetrafluoroethylene coated neoprene O-ring.

11. The pressure relief valve of claim 7, wherein the cone of the piston defines a cone surface and wherein the cone surface is defined by passing a line through a fixed vertex point and moving the line along a fixed directrix curve.

12. The pressure relief valve of claim 7, wherein the cone of the piston defines a cone surface and wherein the cone surface is defined by an angle disposed between the cone surface and an axis, wherein the angle defines a value from about 30 degrees through about 60 degrees.

13. In a system used in the refrigeration and air conditioning industry, a pressure relief valve comprising:
a body having a seat disposed in a passageway;
a gasket disposed on the seat;
a piston disposed on the gasket, wherein the piston includes a cone;
an adjusting gland; and
a spring disposed between the piston and the adjusting gland.

14. The pressure relief valve of claim 13, wherein the body includes no more than five machined features.

15. The pressure relief valve of claim 14, wherein the machined features are arranged with respect to one another such that the machined features are adapted to be produced in one step.

16. The pressure relief valve of claim 13, wherein the gasket is a polytetrafluoroethylene coated neoprene O-ring.

17. The pressure relief valve of claim 13, wherein the cone of the piston defines a cone surface and wherein the cone surface is defined by passing a line through a fixed vertex point and moving the line along a fixed directrix curve.

18. The pressure relief valve of claim 13, wherein the cone of the piston defines a cone surface and wherein the cone surface is defined by an angle disposed between the cone surface and an axis, wherein the angle defines a value from about 30 degrees through about 60 degrees.

19. A method of producing a pressure relief valve, the method comprising:
machining a body having a seat in one step to create a passageway;
disposing a gasket on the seat;
assembling a piston into the gasket, wherein the piston includes a cone;
coupling a spring between the piston and an adjusting gland to form a controlling parts assembly;
placing the controlling parts assembly within the passageway;
establishing the set pressure of the spring to form the pressure relief valve, wherein the time period between machining the body and establishing the set pressure is less than a 24 hour continuous period.

20. The method of claim 19, wherein the method further comprises:
performing the formation of the controlling parts assembly and the establishment of the set pressure in a first location; and
sending the pressure relief valve to a second location within the 24 hour continuous period.
